(19) United States
(12) Patent Application Publication
(10) Pub. No.: US 2026/0172669 A1
(43) Pub. Date: Jun. 18, 2026

(54) DISPLAY ADJUSTMENT METHOD, DEVICE, ELECTRONIC DEVICE, AND COMPUTER STORAGE MEDIA

(71) Applicant: Arashi Vision Inc., Shenzhen (CN)

(72) Inventors: Zhiyuan Zheng, Shenzhen (CN); Yuanjia Cai, Shenzhen (CN)

(73) Assignee: Arashi Vision Inc., Shenzhen (CN)

(21) Appl. No.: 19/532,145

(22) Filed: Feb. 6, 2026

Related U.S. Application Data
(63) Continuation of application No. PCT/CN2024/109470, filed on Aug. 2, 2024.

(30) Foreign Application Priority Data
Aug. 7, 2023 (CN) 202310991372.4

(51) Int. Cl. H04N 23/63; G06F 3/04845; H04N 23/68

(52) U.S. Cl. CPC H04N 23/632; G06F 3/04845; H04N 23/6812

(57) ABSTRACT

A display adjustment device includes at least one processor; at least one memory; and one or more application programs. The one or more application programs are stored in the at least one memory and configured to, when executed by the at least one processor, implement a display adjustment method, which comprises steps of acquiring a target image captured by a first terminal; adjusting the target image according to a preset image adjustment rule to obtain an adjusted target image; and displaying the adjusted target image on a second terminal for preview. The preset image adjustment rule is determined based on a first posture of the first terminal and/or a second posture of the second terminal.

### CROSS-REFERENCE TO RELATED APPLICATIONS

The present application is a continuation of International Application No. PCT/CN2024/109470, filed Aug. 2, 2024, which claims priority to Chinese Patent Application No. 202310991372.4, filed Aug. 7, 2023, the entire content of each of which being incorporated herein by reference in their entirety.

### TECHNICAL OF FIELD

This application relates to a field of image processing technology, and more specifically to a display adjustment method, an apparatus, an electronic device, and a computer storage medium.

### BACKGROUND

With development of smart terminal hardware technology, performance of a smart terminal is getting better and better. The smart terminal can capture images from all directions and multiple angles according to a user's need.

### SUMMARY

In a first aspect, a display adjustment device includes at least one processor; at least one memory; and one or more application programs, wherein the one or more application programs are stored in the at least one memory and configured to, when executed by the at least one processor, implement a display adjustment method, which comprises steps of:
acquiring a target image captured by a first terminal; adjusting the target image according to a preset image adjustment rule to obtain an adjusted target image; and displaying the adjusted target image on a second terminal for preview, wherein the preset image adjustment rule is determined based on a first posture of the first terminal and/or a second posture of the second terminal.

In a second aspect, an electronic device includes a first terminal and/or a second terminal, wherein the first terminal is a shooting terminal, and the second terminal is a display terminal including a display screen; at least one processor; at least one memory; and one or more application programs, wherein the one or more application programs are stored in the at least one memory and configured to, when executed by the at least one processor, implement a display adjustment method, which comprises steps of:
acquiring a target image captured by the first terminal; adjusting the target image according to a preset image adjustment rule to obtain an adjusted target image; and displaying the adjusted target image on the second terminal for preview, wherein the preset image adjustment rule is determined based on a first posture of the first terminal and/or a second posture of the second terminal.

In a third aspect, a non-transitory computer storage medium, wherein it stores a computer program thereon, the computer program being loaded by a processor to execute steps of display adjustment method which comprises: acquiring a target image captured by the first terminal; adjusting the target image according to a preset image adjustment rule to obtain an adjusted target image; and displaying the adjusted target image on the second terminal for preview, wherein the preset image adjustment rule is determined based on a first posture of the first terminal and/or a second posture of the second terminal.

### BRIEF DESCRIPTION OF THE DRAWINGS

To more clearly illustrate the technical solutions in the embodiments of this application or the conventional technology, the drawings used in the description of the embodiments or the conventional technology will be briefly introduced below. Obviously, the drawings described below are only some embodiments of this application. For those skilled in the art, other drawings can be obtained based on these drawings without creative effort.

FIG. 1 is a schematic diagram of a structural scenario of an electronic device to which a display adjustment method is applied according to an embodiment of this application;

FIG. 2 is a schematic diagram of a structural scenario of the display terminal to which a display adjustment method of is applied according to an embodiment of this application;

FIG. 3 is a flowchart of a display adjustment method provided according to an embodiment of this application;

FIG. 4 is a flowchart of a display adjustment method provided according to an embodiment of this application;

FIG. 5 is a flowchart of a display adjustment method provided according to an embodiment of this application;

FIG. 6 is a flowchart of a display adjustment method for adjusting a display interface according to an embodiment of this application;

FIG. 7 is a schematic diagram of an application scenario of a display adjustment method provided according to an embodiment of this application;

FIG. 8 is a schematic diagram of a display adjustment device provided according to an embodiment of this application.

### DETAILED DESCRIPTION

The technical solutions of the embodiments of this application will be clearly and completely described below with reference to the accompanying drawings. Obviously, the described embodiments are only some embodiments of the present disclosure, and not all embodiments. Based on the embodiments of the present disclosure, all other embodiments obtained by those skilled in the art without creative effort are within the scope of protection of the present disclosure.

In the description of this disclosure, it should be understood that the terms “center,” “longitudinal,” “lateral,” “length,” “width,” “thickness,” “upper,” “lower,” “front,” “rear,” “left,” “right,” “vertical,” “horizontal,” “top,” “bottom,” “inner,” and “outer,” etc., indicating orientation or positional relationships based on the orientation or positional relationships shown in the accompanying drawings, are only for the convenience of describing the disclosure and simplifying the description, and do not indicate or imply that the device or element referred to must have a specific orientation, or be constructed and operated in a specific orientation, and therefore should not be construed as a limitation of the disclosure. Furthermore, the terms “first” and “second” are used for descriptive purposes only and should not be construed as indicating or implying relative importance or implicitly specifying the number of indicated technical features. Thus, features defined with “first” and “second” may explicitly or implicitly include one or more of the stated features. In the description of this disclosure, “a plurality of” means two or more, unless otherwise explicitly specified.

In this application, the term “exemplary” is used to mean “serving as an example, illustration, or description.” Any embodiment described as “exemplary” in this application is not necessarily to be construed as being more preferred or advantageous than other embodiments. The following description is provided to enable any person skilled in the art to make and use the disclosure. Details are set forth in the following description for purposes of explanation. It should be understood that those skilled in the art will recognize that the disclosure can be made without using these specific details. In other instances, well-known structures and processes will not be described in detail to avoid obscuring the description of the disclosure with unnecessary detail. Therefore, the disclosure is not intended to be limited to the embodiments shown, but is consistent with the broadest scope of the principles and features disclosed in this application.

A display adjustment method according to one embodiment of this application is applied to an electronic device having a first terminal and a second terminal; wherein, the first terminal can be a shooting terminal; the second terminal can be a display terminal, which can be a smart device such as a mobile phone or tablet computer with wired communication interface and/or wireless communication interface. Alternatively, the display terminal can also be a remote control of the shooting terminal.

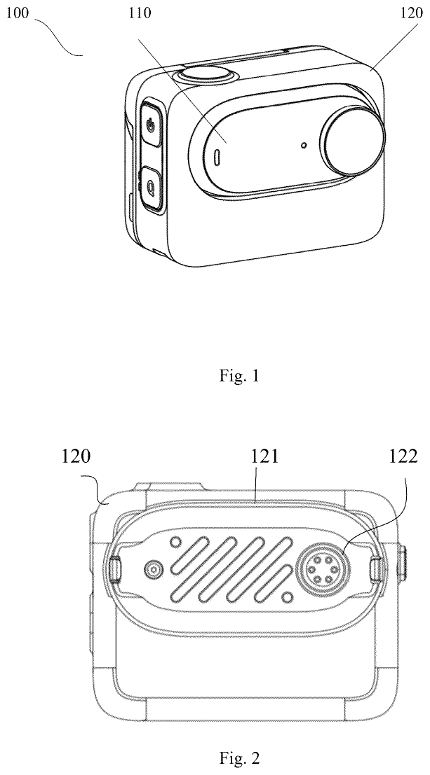

For example, referring to FIG. 1, which is a schematic diagram of a structural scenario of an electronic device to which the display adjustment method is applied according to one embodiment of the present application. The display adjustment method in the embodiment of this application is applied to an electronic device 100, which includes: a first terminal 110 and a second terminal 120, wherein the first terminal 110 has at least two in-situ states relative to the second terminal 120.

The electronic device 100 includes one or more processors; a memory; and one or more application programs, wherein the one or more application programs are stored in the memory and configured to, when executed by the processor, implement steps of the display adjustment method described in any of the following embodiments of the present application.

In one embodiment, the first terminal 110 can be a shooting terminal, which has a camera module for acquiring images and a sensor for detecting shooting posture. In one embodiment, the sensor includes an accelerometers and a gyroscopes.

It should be further noted that the types of the camera module and the sensor in the shooting terminal according to one embodiment of this application do not constitute limitation on the technical solution of this application. The functions and performance of the camera module and the sensor can be customized according to different application requirements. For example, due to the compact space, a small electronic device usually needs to have a smaller and lighter camera module; a camera module for a monitoring electronic device focuses more on ability to operate stably for a long time and monitor from a distance; and a user of an action camera electronic device has a need for high-quality images, so the camera module is usually of higher resolution.

Referring to FIG. 2, which is a schematic diagram of a structural scenario of a display terminal to which the display adjustment method is applied according to one embodiment of this application. This application embodiment employs a display terminal 120 with a charging compartment as an example. The charging compartment may be provided with a mounting slot 121, and a USB communication interface 122 is provided in the mounting slot for communicating with and supplying power to the shooting terminal 110. The display terminal is also provided with a display screen for displaying images captured by the shooting terminal 110.

The display terminal 120 can also serve as a controller for the shooting terminal 110, requiring control signals to be sent to the shooting terminal 110, such as for taking photos or recording videos. In one embodiment, both the shooting terminal 110 and the display terminal 120 are equipped with a controller, a USB (Universal Serial Bus) interface 122, and a wireless communication module (not shown).

In the above embodiments, the type of the first terminal 110 or the second terminal 120, or the types of the first terminal 110 and the second terminal 120, do not constitute limitation on the embodiments of the present disclosure. In other embodiments, it can also be other devices with at least two in-situ states and requiring switching of communication links. As long as it does not affect the overall implementation of the technical solution in the embodiments of this application, it can be considered as an equivalent substitution or derivative of the technical solution claimed in the embodiments of the present application.

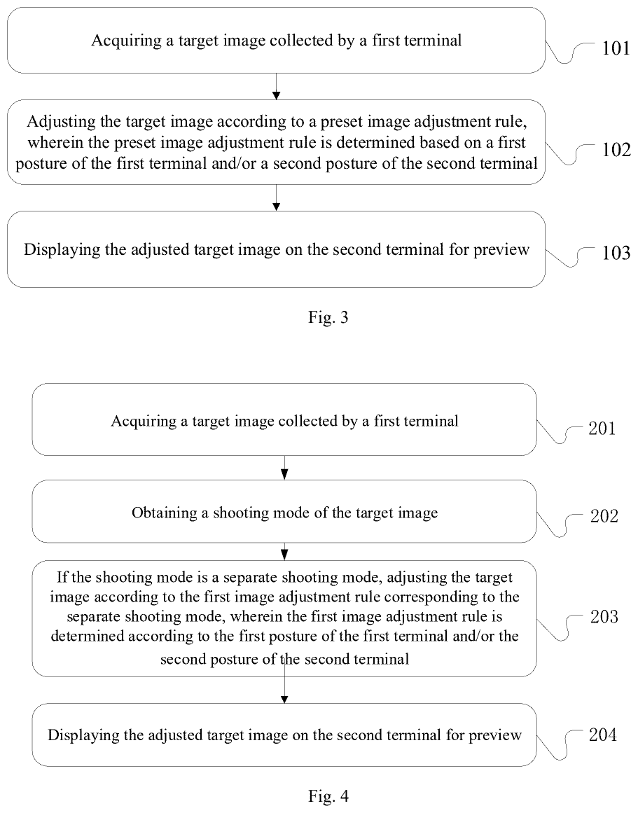

Referring to FIG. 3, which is a flowchart of a display adjustment method according to one embodiment of the present application, the display adjustment method includes the following steps 101 to 103:
Step 101: acquiring a target image collected by a first terminal.

In this embodiment, the display adjustment method is applied to an electronic device. The type of electronic device is not specifically limited. For example, the electronic device may be a shooting terminal, a display terminal, a server or other terminal that communicates with the shooting terminal and the display terminal.

The electronic device acquires the target image captured by the camera module in the shooting terminal, as well as a shooting posture associated with the target image. The shooting posture refers to a position and an orientation of the camera module in the shooting terminal when the target image is acquired. The shooting posture is obtained by processing sensing data detected by a gyroscope sensor in the shooting terminal.
Step 102: adjusting the target image according to a preset image adjustment rule, wherein the preset image adjustment rule is determined based on a first posture of the first terminal and/or a second posture of the second terminal.

A preset image adjustment rule of an electronic device refers to a rule determined by the electronic device based on an image shooting scene and at least one of a shooting posture of the shooting terminal or a display posture of the display terminal. For example, the preset image adjustment rule includes: a first image adjustment rule corresponding to the shooting scene where the shooting terminal and the display terminal are separated; and a second image adjustment rule corresponding to the shooting scene where the shooting terminal and the display terminal are integrated. The first image adjustment rule is determined based on the shooting posture of the shooting terminal and the display posture of the display terminal, and the second image adjustment rule is determined based on the shooting posture of the shooting terminal.

In one embodiment, that the electronic device adjusts the target image according to the preset image adjustment rule includes: performing image adjustment operation based solely on the shooting posture of the shooting terminal. The image adjustment operation can be performed via the shooting terminal or via a display terminal. This embodiment may include the following:
Method 1: The shooting terminal obtains its own shooting posture, which includes at least one of rotations of 90°, 180° or 270°; the shooting terminal performs rotation correction operation on the target image based on its own shooting posture, and the rotation angle includes at least one of 90°, 180° or 270°.
Method 2: The shooting terminal obtains its own shooting posture, which includes at least one of rotations of 90°, 180° or 270°; the shooting terminal associates the shooting posture with the target image and sends it to the display terminal; the display terminal performs rotation correction operation on the target image according to the shooting posture, and the rotation angle includes at least one of 90°, 180° or 270°.

Based on the above implementation methods, according to one embodiment of the present application, the electronic device adjusts the target image according to a preset image adjustment rule. Specifically, this includes image adjustment operation based on the shooting posture of the shooting terminal and the display posture of the display terminal. The image adjustment operation can be performed through the shooting terminal or through the display terminal.
Method 3: The display terminal obtains its own display posture and sends it to the shooting terminal. The display posture of the display terminal may include at least one of the following: a display screen of the display terminal rotates by 90°, 180° or 270°. The shooting terminal performs rotation correction operation on the target image according to the shooting posture and the display posture of the display terminal. The rotation angle includes at least one of the following: 90°, 180° or 270°.
Method 4: The display terminal obtains its own display posture, which includes at least one of the following: a display screen of the display terminal rotates by 90°, 180°, or 270°; the display terminal performs rotation correction operation on the target image based on the obtained shooting posture of the shooting terminal and its own display posture, and the rotation angle includes at least one of the following: 90°, 180°, or 270°.

In other embodiments, the first and second postures can also be at other angles, such as 45 degrees. This implementation method makes the image previewed on the second terminal more suitable for viewing. For example, the preview image can be an image in a positive orientation. Here, “positive orientation” refers to an orientation that matches the monitor's orientation, so no rotational correction is required.
Step 103: displaying the adjusted target image on the second terminal for preview.

The adjusted target image is acquired and displayed on the display terminal for user preview. In the technical solution according to one embodiment of this application, the electronic device consists of at least two terminal devices. When displaying the captured image, the target image is adjusted according to the preset image adjustment rule determined by the first posture of the first terminal and/or the second posture of the second terminal. The adjusted target image is then displayed on the second terminal for preview. In a multi-terminal shooting scenario, the image is captured and displayed separately by two terminals, which facilitates user preview.

Referring to FIG. 4, which is a flowchart of a display adjustment method according to one embodiment of the present application, the display adjustment method may include the following steps 201 to 204:
Step 201: acquiring a target image collected by a first terminal.

An electronic device acquires the target image captured by a camera module in a shooting terminal, as well as a shooting posture associated with the target image. The shooting posture refers to a position and an orientation of the camera module in the shooting terminal when the target image is acquired. The shooting posture is obtained by processing sensing data detected by a gyroscope sensor in the shooting terminal.

The electronic device rotates the captured target image according to the shooting posture to obtain the target image in a positive orientation. In this embodiment, the captured target image is first rotated according to the shooting posture of the shooting terminal so that the target image is in a reference state. This makes it easier to further process the target image and meet the preview requirements of the display terminal.
Step 202: obtaining a shooting mode of the target image.

The shooting mode in this embodiment determines the basis for adjusting the target image. The shooting mode is used to provide feedback on a relative positional relationship between the shooting terminal and the display terminal when the target image is captured. Based on the shooting mode of the target image, the electronic device can further determine an image adjustment rule of the target image, thereby realizing the adjustment of the target image.

In one embodiment of this application, that the electronic device determines the shooting mode of the target image based on at least one of a positional status, a power supply status, or a communication status between the shooting terminal and the display terminal specifically includes:
Method 1 for determining the shooting mode: The shooting terminal and the display terminal are detachably connected; the electronic device acquires the positional status of the shooting terminal and the display terminal when the target image is captured. The positional status between the shooting terminal and the display terminal includes an integrated setup and a separated setup; if the shooting terminal and the display terminal are set separately, the electronic device determines that the shooting mode of the target image is a separate shooting mode; if the shooting terminal and the display terminal are set integrally as one unit, the electronic device determines that the shooting mode of the target image is an integrated shooting mode.
Method 2 for determining the shooting mode: The display terminal is equipped with a charging compartment for the shooting terminal. A power supply priority of the battery in the display terminal is higher than that of the battery in the shooting terminal. When the electronic device acquires the target image, it determines the power supply status between the shooting terminal and the display terminal. The power supply status between the shooting terminal and the display terminal includes a power connection status and a power disconnect status. If the shooting terminal and the display terminal are in a power disconnect status, the electronic device determines the target image shooting mode as a separate shooting mode. If the shooting terminal and the display terminal are in a power connection status, the electronic device determines the target image shooting mode as an integrated shooting mode.
Method 3 for determining the shooting mode: Both the shooting terminal and the display terminal are equipped with compatible communication transmission interfaces or electronic components. The shooting terminal and the display terminal can transmit the target image through these communication transmission interfaces or electronic components. The electronic device acquires the communication status of the shooting terminal and the display terminal when the target image is acquired. The communication status between the shooting terminal and the display terminal includes wired communication through the communication transmission interfaces or electronic components and wireless communication through a short-range transmission method such as Bluetooth or a long-range transmission method such as a network. If the shooting terminal and the display terminal are in the wireless communication mode, the electronic device determines that the shooting mode of the target image is the separate shooting mode; if the shooting terminal and the display terminal are in the wired communication mode, the electronic device determines that the shooting mode of the target image is the integrated shooting mode.

Furthermore, in one embodiment, the electronic device can combine the above three implementation methods to determine the shooting mode of the target image. For example, if the shooting terminal and the display terminal are set separately, the battery in the shooting terminal directly powers the shooting process, and the shooting terminal and the display terminal are connected through wireless communication, then the electronic device determines the shooting mode of the target image as the separate shooting mode; if the shooting terminal and the display terminal are set as one unit, the charging compartment in the display terminal charges or powers the shooting terminal, and the shooting terminal and the display terminal are directly connected through their own communication transmission interfaces or electronic components, then the electronic device determines the shooting mode of the target image as the integrated shooting mode.

It should be added that if the target image shooting modes determined by the above three methods are different, the electronic device will analyze according to the specific situation. For example, the electronic device can set different priorities. The electronic device has the highest priority for the target image shooting mode determined by method one, the second highest priority for the target image shooting mode determined by method two, and the lowest priority for the target image shooting mode determined by method three.
Step 203: If the shooting mode is a separate shooting mode, adjusting the target image according to the first image adjustment rule corresponding to the separate shooting mode, wherein the first image adjustment rule is determined according to the first posture of the first terminal and/or the second posture of the second terminal.

The electronic device acquires a first image adjustment rule corresponding to the separate shooting mode, wherein the first image adjustment rule refers to the image adjustment rule determined based on the shooting posture of the shooting terminal and/or the display posture of the display terminal.

In one embodiment, the shooting posture of the shooting terminal represents a tilt angle of the camera module in the shooting terminal when the target image is acquired. The shooting posture is obtained by processing first sensing parameters collected by a first sensor in the shooting terminal. In one embodiment, the first sensor in the shooting terminal may include at least an accelerometer and a gyroscope. The accelerometer in the shooting terminal is configured to detect motion information of the shooting terminal, and the gyroscope is configured to detect rotation information of the camera module in the display terminal.

The display posture represents a screen rotation angle of a display screen in the display terminal when the target image is displayed. The display posture is obtained by processing second sensing parameters collected by a second sensor in the display terminal. In one embodiment, the second sensor may include an accelerometer, which is set on the display screen of the display terminal.

In one embodiment of this application's technical solution, by comparing the acceleration information detected by the accelerometer in the shooting terminal with the acceleration information detected by the accelerometer in the display terminal, it can be determined whether the shooting terminal and the display terminal are in the same motion state. Furthermore, by combining with the detection data from the gyroscope in the shooting terminal, it can be determined whether the display screen in the display terminal is flipped.

For example, if the acceleration information detected by the accelerometer in the shooting terminal is different from the acceleration information detected by the accelerometer in the display terminal, the electronic device determines that the shooting mode of the target image is a separate shooting mode; furthermore, if the detection data of the gyroscope in the shooting terminal and the detection data of the accelerometer in the display terminal are different, it is determined that the display screen in the display terminal is flipped.

For example, if the acceleration information detected by the accelerometer in the shooting terminal is the same as that detected by the accelerometer in the display terminal, and the detection data of the gyroscope and the detection data of the accelerometer are also the same, the electronic device determines that the shooting mode of the target image is an integrated shooting mode, and the display screen in the display terminal is not flipped. If the acceleration information detected by the accelerometer in the shooting terminal is the same as that detected by the accelerometer in the display terminal, and the detection data of the gyroscope and the detection data of the accelerometer are different, the electronic device determines that the shooting mode of the target image is the integrated shooting mode, and the display screen in the display terminal is flipped.

It is understood that in one embodiments of this application, the electronic device can determine the shooting posture of the shooting terminal and the display posture of the display terminal by detecting data with more or fewer sensors. The description of the sensors in the embodiments of this application does not constitute a limitation on the display adjustment method.

In one embodiment, the electronic device obtains the shooting posture of the shooting terminal and the display posture of the display terminal. Since there is no direct correlation between the positions of the shooting terminal and the display terminal in the separate shooting mode, the electronic device can determine the first image adjustment rule based solely on the shooting posture of the shooting terminal, solely on the display posture of the display terminal, or based on both the shooting posture of the shooting terminal and the display posture of the display terminal.
Method 1 for determining an image adjustment rule: The electronic device determines that the shooting mode of the target image is a separate shooting mode based on the shooting posture of the shooting terminal and the display posture of the display terminal. The display screen of the display terminal is not flipped. Therefore, the electronic device determines the first image adjustment rule based on the shooting posture of the shooting terminal.
Method 2 for determining an image adjustment rule: The electronic device determines the shooting mode of the target image as a separate shooting mode based on the shooting posture of the shooting terminal and the display posture of the display terminal. The display screen of the display terminal is flipped. Therefore, the electronic device determines the first image adjustment rule based on the display posture of the display terminal.
Method 3 for determining an image adjustment rule: The electronic device determines the shooting mode of the target image as a separate shooting mode based on the shooting posture of the shooting terminal and the display posture of the display terminal, and a screen rotation angle of the display terminal is 90°. The electronic device first determines an initial rotation adjustment rule of the target image based on the shooting posture of the shooting terminal. Then, the electronic device determines a secondary rotation adjustment rule of the target image based on the display posture of the display terminal. The electronic device associates the initial rotation adjustment rule and the secondary rotation adjustment rule as the first image adjustment rule.

The electronic device adjusts the target image according to the determined first image adjustment rule to obtain the adjusted target image. For example, the electronic device rotates the target image twice according to the first image adjustment rule determined by the implementation method 3 of the image adjustment rule to obtain the adjusted target image.

For ease of understanding, in one embodiment of the application, that the electronic device adjusts the target image acquired in the separate shooting mode specifically includes:
if the shooting mode is the separate shooting mode, performing a rotation correction operation on the target image according to the first image adjustment rule corresponding to the first posture of the first terminal in the separate shooting mode; wherein a rotation angle of the first image adjustment rule includes at least one of 90°, 180° or 270°.

That is, if the shooting mode is the separate shooting mode, the electronic device adjusts the target image according to the first image adjustment rule. Specifically, this includes: the electronic device adjusting the target image only based on the shooting posture of the shooting terminal; the electronic device adjusting the target image based on the display posture of the display terminal; or the electronic device adjusting the target image based on both the shooting posture of the shooting terminal and the display posture of the display terminal. For example, the electronic device determines that the display screen of the display terminal has rotated based on the display posture of the display terminal in the separate shooting mode, and determines the corresponding first image adjustment rule based on the rotation angle of the display screen to perform rotation correction operation on the target image; wherein the rotation angle of the first image adjustment rule includes at least one of 90°, 180°, or 270°.
Step 204: displaying the adjusted target image on the second terminal for preview.

The adjusted target image of the electronic device is displayed on the display terminal for preview. It should be noted that in this embodiment, the adjusted target image is only used for image preview on the display terminal; the electronic device needs to save the target image in the positive orientation captured by the camera module for later playback.

In this embodiment, after the electronic device acquires the target image and the shooting mode of the target image, the electronic device determines that the shooting terminal and the display terminal are set separately when the target image is shot. The electronic device determines the first image adjustment rule corresponding to the separate shooting mode according to the shooting posture of the shooting terminal and the display posture of the display terminal. Furthermore, the electronic device adjusts the target image according to the first image adjustment rule corresponding to the separate shooting mode and displays the adjusted target image on the display terminal. No manual adjustment by the user is required, which meets the user's preview needs under different conditions of the shooting terminal and the display terminal.

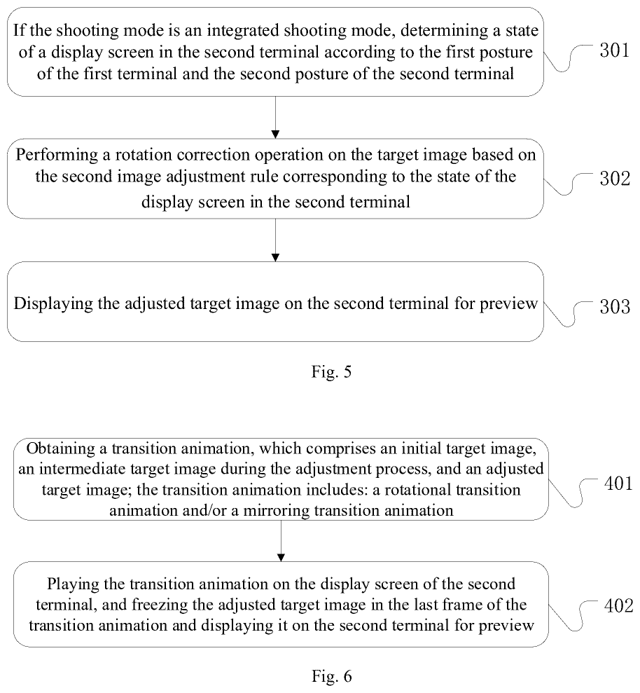

Referring to FIG. 5, which is a flowchart of an adjustment method according to one embodiment of the present application. The electronic device was described in the separate shooting mode for the target image in previous embodiments. In this embodiment, after obtaining the shooting mode of the target image, if it is determined that the shooting mode of the target image is an integrated shooting mode, the method includes steps 301-303:
Step 301: if the shooting mode is an integrated shooting mode, determining a state of a display screen in the second terminal according to the first posture of the first terminal and the second posture of the second terminal.

If the shooting mode is an integrated shooting mode, the electronic device determines a relative position of the display screen in the shooting terminal and the display terminal based on the shooting posture of the shooting terminal and the display posture of the display terminal, thereby determining the state of the display screen in the display terminal. In the embodiments of this application, the state of the display screen includes at least two states: the display screen is not flipped and the display screen is flipped.
Step 302: performing a rotation correction operation on the target image based on the second image adjustment rule corresponding to the state of the display screen in the second terminal.

The electronic device determines a second image adjustment rule for the target image based on the state of the display screen in the display terminal. The second image adjustment rule is determined based on a flip angle of the display screen in the display terminal. For example, if the flip angle of the display screen in the display terminal is 90°, the electronic device determines that the second image adjustment rule is no processing; if the flip angle of the display screen in the display terminal is 161°, the electronic device determines that the second image adjustment rule is a mirroring correction operation.

For ease of understanding, in this embodiment of the application, the electronic device can set the state of the display screen in the display terminal to two states: a flipped state and a not flipped state. The flipped state refers to the display screen rotating more than a first preset angle. For example, the first preset angle can be 90°, 120°, 160° or other degrees. Conversely, the not flipped state refers to the display screen rotating no more than the first preset angle.

In one embodiment, if the display screen in the display terminal is in a flipped state, the electronic device performs mirroring correction operation on the target image according to the second image adjustment rule; wherein the second image adjustment rule includes horizontal mirroring and vertical mirroring.
303: displaying the adjusted target image on the second terminal for preview.

The adjusted target image of the electronic device is displayed on the display terminal for preview. It should be noted that in this embodiment, the adjusted target image is only used for image preview on the display terminal; the electronic device needs to save the target image in the positive orientation captured by the camera terminal for later playback.

In this embodiment, after the electronic device acquires the target image and the shooting mode of the target image, the electronic device determines that the shooting terminal and the display terminal are set integrally as a single unit when the target image is being shot. The electronic device determines the second image adjustment rule corresponding to the integrated shooting mode based on the shooting posture of the shooting terminal and the display posture of the display terminal. Then, the electronic device adjusts the target image according to the second image adjustment rule corresponding to the integrated shooting mode and displays the adjusted target image on the display terminal. No manual adjustment by the user is required, which meets the user's preview needs under different shooting terminal and display terminal conditions.

Referring to FIG. 6, which is a flowchart a display adjustment method provided according to one embodiment of the present application. This embodiment is based on the above embodiments of this application. This embodiment refines the steps of displaying the adjusted target image to the second terminal for preview. This embodiment includes steps 401-402:
Step 401: obtaining a transition animation, which comprises an initial target image, an intermediate target image during the adjustment process, and an adjusted target image; the transition animation includes: a rotational transition animation and/or a mirroring transition animation.

The electronic device acquires the target image at the initial positive orientation, the target image at the intermediate state during the adjustment process, and the target image after adjustment. The electronic device arranges the target image at the initial positive orientation, the target image at the intermediate state during the adjustment process, and the target image after adjustment in chronological order to form a transition animation. Since the image adjustment rule includes a rotation adjustment rule and a mirroring adjustment rule, the transition animation includes a rotational transition animation and/or a mirroring transition animation.
Step 402: playing the transition animation on the display screen of the second terminal, and freezing the adjusted target image in the last frame of the transition animation and displaying it on the second terminal for preview.

The electronic device plays a transition animation on the display screen of the display terminal, and freezes the last frame of the transition animation to display the adjusted target image on the display terminal for preview, so that a user can understand the image adjustment process information.

This embodiment is based on the above embodiments of this application. This embodiment is a refinement of the steps before step 204 or step 303, which involves displaying the adjusted target image to the second terminal for preview. The embodiment of this application may include:
based on the second posture of the second terminal, rotating a display interface on the display screen of the second terminal to obtain a positive orientation display interface so that the adjusted target image can be displayed on the positive orientation display interface.

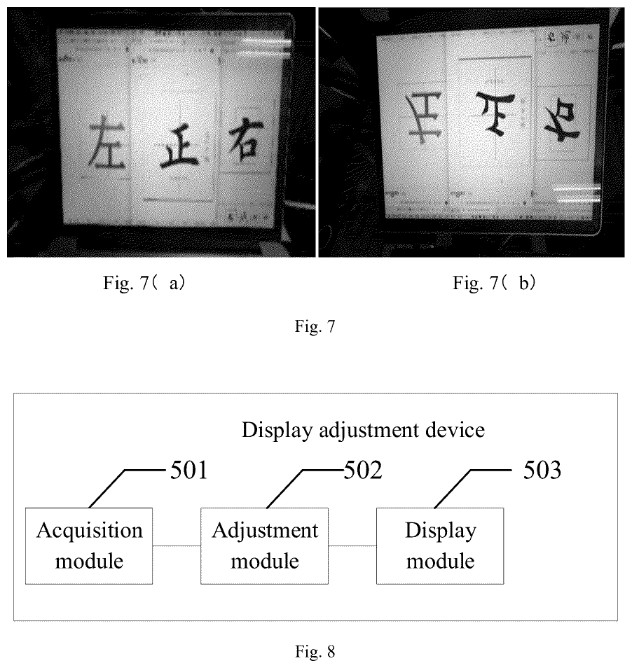

Referring to FIG. 7, which is a schematic diagram of an application scenario of a display adjustment method provided in this application; FIG. 7(a) shows that when the display screen of the display terminal is flipped up more than 160°, the display interface (including GUI) in the display screen of the display terminal rotates 180° clockwise and the left and right mirroring images become the target image of the selfie preview. FIG. 7(b) shows the effect of direct rotation and mirroring of the screen preview in the screen orientation without flipping.

In this embodiment, the electronic device rotates the display interface on the screen of the display terminal according to the display posture of the display terminal to obtain a positive orientation display interface, so as to display the adjusted target image on the positive orientation display interface, making it more convenient for the user to preview.

Referring to FIG. 8, which is a schematic diagram of a display adjustment device provided according to one embodiment of the present application.

This disclosure provides a display adjustment device, comprising:
an acquisition module 501 configured to acquire a target image collected by the first terminal;
an adjustment module 502 configured to adjust the target image according to a preset image adjustment rule, wherein the preset image adjustment rule is determined based on the first posture of the first terminal and/or the second posture of the second terminal; and
a display module 503 configured to display the adjusted target image on the second terminal for preview.

In some embodiments of this application, the display adjustment device is further configured to:
obtain the first posture of the first terminal, wherein the first posture includes at least one of rotations of 90°, 180° or 270°;
perform a rotation correction operation on the target image by the second terminal based on the first posture of the first terminal, wherein the rotation angle includes at least one of 90°, 180° or 270°.

In some embodiments of this application, the display adjustment device is further configured to:
obtain a second posture of the second terminal, wherein the second posture of the second terminal includes at least one of rotations of 90°, 180° or 270°;
perform a rotation correction operation on the target image based on the first posture of the first terminal and the second posture of the second terminal, wherein the rotation angle includes at least one of 90°, 180° or 270°.

In some embodiments of this application, the display adjustment device is further configured to:
obtain the shooting mode of the target image;
if the shooting mode is a separated shooting mode, perform a rotation correction operation on the target image according to the first image adjustment rule corresponding to the separate shooting mode;
if the shooting mode is an integrated shooting mode, perform a rotation correction operation on the target image according to the second image adjustment rule corresponding to the integrated shooting mode.

In some embodiments of this application, the display adjustment device is further configured to:
if the shooting mode is a separate shooting mode, perform a rotation correction operation on the target image according to the first image adjustment rule corresponding to the first posture of the first terminal in the separate shooting mode,
wherein a rotation angle of the first image adjustment rule includes at least one of 90°, 180° or 270°.

In some embodiments of this application, the display adjustment device is further configured to:
if the shooting mode is an integrated shooting mode, determine a state of the display screen in the second terminal according to the first posture of the first terminal and the second posture of the second terminal.

Perform a rotation correction operation on the target image according to the second image adjustment rule corresponding to the state of the display screen in the second terminal.

In some embodiments of this application, the display adjustment device is further configured to:
if the shooting mode is a separate shooting mode, perform a rotation correction operation on the target image according to the first image adjustment rule corresponding to the first posture of the first terminal in the separate shooting mode,
wherein the rotation angle of the first image adjustment rule includes at least one of 90°, 180° or 270°.

In some embodiments of this application, the display adjustment device is further configured to:
if the shooting mode is an integrated shooting mode, determine a state of the display screen in the second terminal according to the first posture of the first terminal and the second posture of the second terminal;
perform a rotation correction operation on the target image according to the second image adjustment rule corresponding to the state of the display screen in the second terminal; and
display the adjusted target image on the second terminal for preview.

In some embodiments of this application, that the display adjustment device performs a rotation correction operation on the target image according to the second image adjustment rule corresponding to the state of the display screen in the second terminal includes:
if the display screen in the second terminal is in a flipped state, mirroring the target image according to the second image adjustment rule. The flipped state refers to the display screen being rotated beyond a first preset angle. The second image adjustment rule includes a horizontal mirroring and a vertical mirroring.

In some embodiments of this application, the display adjustment device is further configured to:
obtain a transition animation, which comprises an initial target image, an intermediate target image during the adjustment process, and an adjusted target image; the transition animation includes: a rotational transition animation and/or a mirroring transition animation; and
play the transition animation on the display screen of the second terminal, and display the adjusted target image in the last frame of the transition animation on the second terminal for preview.

In some embodiments of this application, the display adjustment device is further configured to:
obtain the first posture of the first terminal and the second posture of the second terminal;
the first posture represents a tilt angle of the camera module in the first terminal when the target image is acquired, and is obtained by processing first sensing parameters acquired by a first sensor in the first terminal;
the second posture represents a screen flip angle of the display screen in the second terminal when the target image is displayed, and is obtained by processing second sensing parameters collected by a second sensor in the second terminal;
wherein the first sensor includes an accelerometer and a gyroscope; and the second sensor includes an accelerometer.

In some embodiments of this application, the acquisition module 501 in the display adjustment device is configured to:
acquire the target image through the first terminal; and
based on the first posture of the first terminal, rotate the target image to obtain the target image in the positive orientation acquired by the first terminal.

In some embodiments of this application, before the display adjustment device displays the adjusted target image to the second terminal for preview, the display adjustment device is further configured to:
based on the second posture of the second terminal, rotate the display interface on the screen of the second terminal to obtain a positive orientation display interface so that the adjusted target image is displayed on the positive orientation display interface.

In some embodiments of this application, the first terminal and the second terminal are detachably connected;
the display adjustment device is also configured to:
obtain a positional state of the first terminal and the second terminal when the target image was captured;
if the first terminal and the second terminal are set separately, determine the shooting mode of the target image to be the separate shooting mode;

If the first terminal and the second terminal are set as a single unit, determine the shooting mode of the target image to be an integrated shooting mode.

In some embodiments of this application, the second acquisition module 502 in the display adjustment device is further configured to:
obtain a power supply status of the first terminal and the second terminal when the target image is captured;
if the first terminal and the second terminal are in a power disconnect state, determine the shooting mode of the target image to be a separate shooting mode; and
if the first terminal and the second terminal are in a power connection state, determine the shooting mode of the target image to be an integrated shooting mode.

In some embodiments of this application, the second acquisition module 502 in the display adjustment device is further configured to:
obtain a communication status between the first terminal and the second terminal at the time the target image was captured;
if the first terminal and the second terminal are connected via wireless communication, determine the shooting mode of the target image to be a separate shooting mode; and
if the first terminal and the second terminal are connected via wired communication, determine the shooting mode of the target image to be an integrated shooting mode.

In one embodiment, the display adjustment device is disposed in an electronic device. The display adjustment device is configured to acquire a target image captured by a first terminal; adjust the target image according to a preset image adjustment rule, wherein the preset image adjustment rule is determined based on the first posture of the first terminal and/or the second posture of the second terminal; and display the adjusted target image on the second terminal for preview. In the technical solution of this embodiment, the electronic device comprises at least two terminal devices. When displaying the captured image, the target image is adjusted according to the preset image adjustment rule determined by the first posture of the first terminal and/or the second posture of the second terminal; the adjusted target image is displayed on the second terminal for preview. In a multi-terminal shooting scenario, the image is captured and displayed separately by two terminals, which is convenient for the user to preview.

One embodiment of this disclosure provides a non-transitory computer-readable storage medium, which may include: read-only memory (ROM), random access memory (RAM), a magnetic disk, or an optical disk, etc. A computer program is stored thereon, which is loaded by a processor to execute the steps of any embodiment of the display adjustment methods provided in this disclosure. For example, the computer program loaded by the processor can execute the above-described display adjustment method.

In the above embodiments, the descriptions of each embodiment have different focuses. For parts not described in detail in a certain embodiment, please refer to the detailed descriptions of other embodiments above, which will not be repeated here.

In practice, each of the above units or structures can be implemented as an independent entity or can be arbitrarily combined to be implemented as the same or several entities. For the specific implementation of each of the above units or structures, please refer to the previous method embodiments, which will not be repeated here.

The above provides a detailed description of a display adjustment method provided by some embodiments of this application. Specific embodiments have been used to illustrate the principles and implementation methods of the present disclosure. The description of the above embodiments is only for the purpose of helping to understand the method and core ideas of the present disclosure. At the same time, for those skilled in the art, there will be changes in the specific implementation methods and application scope based on the ideas of the present disclosure. Therefore, the content of this specification should not be construed as a limitation of the present disclosure.

What is claimed is:

1. A display adjustment device, comprising:
at least one processor;
at least one memory; and
one or more application programs, wherein the one or more application programs are stored in the at least one memory and configured to, when executed by the at least one processor, implement a display adjustment method, which comprises:
acquiring a target image captured by a first terminal;
adjusting the target image according to a preset image adjustment rule to obtain an adjusted target image; and
displaying the adjusted target image on a second terminal for preview;
wherein the preset image adjustment rule is determined based on a first posture of the first terminal and/or a second posture of the second terminal.

2. The display adjustment device according to claim 1, wherein the adjusting the target image according to the preset image adjustment rule to obtain the adjusted target image comprises:
obtaining the first posture of the first terminal; and
performing a rotation correction operation on the target image based on the first posture of the first terminal.

3. The display adjustment device according to claim 1, wherein the adjusting the target image according to the preset image adjustment rule to obtain the adjusted target image comprises:
obtaining the first posture of the first terminal;
obtaining the second posture of the second terminal; and
performing a rotation correction operation on the target image based on the first posture of the first terminal and the second posture of the second terminal.

4. The display adjustment device according to claim 1, wherein
the first posture of the first terminal includes at least one of rotations of 90°, 180°, or 270°; and/or
the second posture of the second terminal includes at least one of rotations of 90°, 180°, and 270°.

5. The display adjustment device according to claim 1, wherein the adjusting the target image according to the preset image adjustment rule to obtain the adjusted target image comprises:
obtaining a shooting mode of the target image;
in a case that the shooting mode is a separate shooting mode, performing a rotation correction operation on the target image according to a first image adjustment rule corresponding to the separate shooting mode; and
in a case that the shooting mode is an integrated shooting mode, performing a rotation correction operation on the target image according to a second image adjustment rule corresponding to the integrated shooting mode.

6. The display adjustment device according to claim 5, wherein the obtaining the shooting mode of the target image comprises:
obtaining a positional state between the first terminal and the second terminal when the target image was captured;
in a case that the first terminal and the second terminal are set separately, determining the shooting mode of the target image to be the separate shooting mode; and
in a case that the first terminal and the second terminal are set as a single unit, determining the shooting mode of the target image to be the integrated shooting mode.

7. The display adjustment device according to claim 5, wherein the obtaining the shooting mode of the target image comprises:
obtaining a power supply status between the first terminal and the second terminal when the target image was captured;
in a case that the first terminal and the second terminal are in a power disconnect state, determining the shooting mode of the target image to be the separate shooting mode; and
in a case that the first terminal and the second terminal are in a power connection state, determining the shooting mode of the target image to be the integrated shooting mode.

8. The display adjustment device according to claim 5, wherein the obtaining the shooting mode of the target image comprises:
obtaining a communication status between the first terminal and the second terminal when the target image was captured;
in a case that the first terminal and the second terminal are connected via wireless communication, determining the shooting mode of the target image to be the separate shooting mode; and
in a case that the first terminal and the second terminal are connected via wired communication, determining the shooting mode of the target image to be the integrated shooting mode.

9. The display adjustment device according to claim 5, wherein a rotation angle of the first image adjustment rule comprises at least one of 90°, 180°, or 270°.

10. The display adjustment device according to claim 5, wherein, in the case that the shooting mode is the integrated shooting mode, the performing the rotation correction operation on the target image according to the second image adjustment rule corresponding to the integrated shooting mode comprises:
determining a state of a display screen in the second terminal according to the first posture of the first terminal and the second posture of the second terminal; and
performing the rotation correction operation on the target image according to the second image adjustment rule corresponding to the state of the display screen in the second terminal.

11. The display adjustment device according to claim 10, wherein the performing the rotation correction operation on the target image according to the second image adjustment rule corresponding to the state of the display screen in the second terminal comprises:
in a case that the display screen in the second terminal is in a flipped state, performing a mirroring correction operation on the target image according to the second image adjustment rule,
wherein the flipped state refers to a state of the display screen rotating beyond a first preset angle, and the second image adjustment rule includes a horizontal mirroring and a vertical mirroring.

12. The display adjustment device according to claim 1, wherein the displaying the adjusted target image to the second terminal for preview comprises:
obtaining a transition animation, which includes an initial target image, an intermediate target image during the adjustment process, and the adjusted target image; the transition animation including a rotational transition animation and/or a mirroring transition animation; and
playing the transition animation on the display screen of the second terminal, and displaying the adjusted target image in the last frame of the transition animation on the second terminal for preview.

13. The display adjustment device according to claim 1, wherein the display adjustment method further comprises:
obtaining the first posture of the first terminal and the second posture of the second terminal;
wherein the first posture represents a tilt angle of a camera in the first terminal when the target image is acquired, and is obtained by processing first sensing parameters acquired by a first sensor in the first terminal,
the second posture represents a screen flip angle of a display screen in the second terminal when the target image is displayed, and is obtained by processing second sensing parameters collected by a second sensor in the second terminal, and
the first sensor includes an accelerometer and a gyroscope, and the second sensor includes an accelerometer.

14. The display adjustment device according to claim 1, wherein the acquiring the target image collected by the first terminal comprises:
acquiring the target image through the first terminal; and
rotating the target image to obtain the target image in a positive orientation acquired by the first terminal based on the first posture of the first terminal.

15. The display adjustment device according to claim 1, wherein, before displaying the adjusted target image to the second terminal for preview, the display adjust method further comprises:
rotating a display interface on the display screen of the second terminal to obtain a positive orientation display interface based on the second posture of the second terminal so that the adjusted target image is displayed on the positive orientation display interface.

16. An electronic device, comprising:
a first terminal and/or a second terminal, wherein the first terminal is a shooting terminal, and the second terminal is a display terminal including a display screen;
at least one processor;
at least one memory; and
one or more application programs, wherein the one or more application programs are stored in the at least one memory and configured to, when executed by the at least one processor, implement a display adjustment method, which comprises:
acquiring a target image captured by the first terminal;
adjusting the target image according to a preset image adjustment rule to obtain an adjusted target image; and
displaying the adjusted target image on the second terminal for preview,
wherein the preset image adjustment rule is determined based on a first posture of the first terminal and/or a second posture of the second terminal.

17. The electronic device according to claim 16, wherein the display terminal comprises a charging compartment, the charging compartment is provided with a mounting slot, and a communication interface is provided in the mounting slot to communicate with and supply power to the shooting terminal.

18. The electronic device according to claim 16, wherein the adjusting the target image according to the preset image adjustment rule to obtain the adjusted target image comprises:
obtaining the first posture of the first terminal;
obtaining the second posture of the second terminal; and
performing a rotation correction operation on the target image based on the first posture of the first terminal and the second posture of the second terminal, and a rotation angle of the rotation correction operation includes at least one of 90°, 180° or 270°.

19. The electronic device according to claim 16, wherein the adjusting the target image according to the preset image adjustment rule to obtain the adjusted target image comprises:
obtaining a shooting mode of the target image;
in a case that the shooting mode is a separate shooting mode, performing a rotation correction operation on the target image according to a first image adjustment rule corresponding to the separate shooting mode; and
in a case that the shooting mode is an integrated shooting mode, performing a rotation correction operation on the target image according to a second image adjustment rule corresponding to the integrated shooting mode.

20. The electronic device according to claim 19, wherein the obtaining the shooting mode of the target image comprises:
obtaining a positional state between the first terminal and the second terminal when the target image was captured;
in a case that the first terminal and the second terminal are set separately, determining the shooting mode of the target image to be the separate shooting mode; and
in a case that the first terminal and the second terminal are set as a single unit, determining the shooting mode of the target image to be the integrated shooting mode.
